(19) United States
(12) Patent Application Publication
(10) Pub. No.: US 2001/0049646 A1
(43) Pub. Date: Dec. 6, 2001

(54) Method for matching financial supply to demand

(76) Inventor: William T. Wilkinson, Salem, NJ (US)

Correspondence Address: Ratner & Prestia, P.O. Box 7228, Wilmington, DE, 19803, US

(21) Appl. No.: 09/759,571

(22) Filed: Jan. 12, 2001

Related U.S. Application Data
(63) Continuation-in-part of application No. 09/669,286, filed on Sep. 26, 2000.
(60) Provisional application No. 60/175,649, filed on Jan. 12, 2000.
(60) Provisional application No. 60/157,119, filed on Oct. 4, 1999.

(51) Int. Cl. G06F 17/60

(52) U.S. Cl. 705/36

(57) ABSTRACT

A method for a service provider to facilitate financial transactions between demanders and suppliers. In one embodiment, the service provider receives a referral from a first supplier regarding a first demander rejected by the first supplier. Data relating to the first demander is entered into a database in association with a confidential demander code. A second supplier, through a database search, is provided information on prospective demanders, initially only by confidential code, and ultimately arranges a meeting with the first demander arranged by the service provider. If the first demander and second supplier consummate a financial transaction, the service provider is compensated and the service provider shares the compensation with the first supplier who referred the first demander. Related methods allow suppliers to search for other suppliers and demanders to search for suppliers or other demanders. Computer program products for carrying out the method steps of the invention are also claimed.

### CROSS-REFERENCE TO RELATED APPLICATIONS

This application claims priority on U.S. Provisional Application Serial No. 60/175,649, filed on Jan. 12, 2000, and is a continuation-in-part of U.S. Patent Application Serial No. 09/669,286, titled “Standard Business/Investment Financing Process,” filed on Sep. 26, 2000, by the common inventor of this application, and which claims priority on U.S. Provisional Application No. 60/157,119, filed on Oct. 4, 1999. Application Ser. Nos. 60/175,649, 09/669,286, and 60/157,119 are all hereby incorporated by reference.

### TECHNICAL FIELD

This invention relates to the flow of capital, and more particularly to a method for helping entities who have a demand for capital find entities who desire to supply capital, and vice versa.

### BACKGROUND OF THE INVENTION

In today's financial world the vast majority of demands or requests for funds or capital are initially rejected. A rejected entity may then continue on by using personal networking, looking in a phone book or a financial publication, or other means to locate other potential suppliers of capital. Similarly, entities with capital to invest may have difficulty finding the types of investments to match their investment criteria. The ultimate matching of suppliers and demanders of capital may therefore often be left to chance, with neither supplier nor demander having an efficient method by which to find a match for its needs.

In particular, suppliers of capital incur considerable expense processing and analyzing requests for capital, including spending considerable time, energy and money meeting with demanders of capital who ultimately are rejected, and referring these rejected demanders to other sources. There is no return to the capital supplier generated from such a rejected request, just expense. For demanders, the capital seeking process is an arduous undertaking of time, expense, and energy.

Thus, there is a need in the art for a financial business method that helps demanders of capital, particularly the vast majority whose requests are initially rejected, better locate suppliers, and vice versa.

### SUMMARY OF THE INVENTION

In accordance with this invention, there is provided a method for a service provider to facilitate one or more financial transactions between one or more suppliers of capital and one or more demanders of capital. The method comprises receiving from a first supplier a referral regarding a first demander rejected by the first supplier. Then, the service provider enters data about the first demander into a database in association with a confidential demander code. The data comprises general and financial information about the first demander and the first demander's request for financing. Next, the service provider facilitates a search of the database by or on behalf of a second supplier to identify one or more prospective demanders that satisfies the second supplier's set of supply criteria. Ultimately, the service provider arranges a meeting between the second supplier and the first demander, and upon the first demander and the second supplier consummating a financial transaction, receives compensation from the first demander, the second supplier, or both, for facilitating the transaction between. The service provider then shares a portion of the compensation with the first supplier.

The identification of the one or more prospective demanders may initially comprise identifying the one or more prospective demanders only by the confidential demander code and general background information, such as the geographical region, amount of funds requested, business/financing stage and industry/product/service type of the demander. Then, after receiving a request from the supplier for additional information on selected prospective demanders, additional information, such as the demander's business plan and executive summary information, may be provided, but with the additional information still preferably cleansed of data from which the identity of the demander can be determined.

The invention may comprise a method for a service provider to facilitate one or more financial transactions between one or more suppliers of capital, one or more demanders of capital, or some combination thereof. The transaction may be between two or more suppliers, two or more demanders, or at least one demander and at least one supplier. The method comprises the steps of collecting data from a plurality of members comprising at least two suppliers, at least two demanders, or a combination thereof, and entering the data for each member into a database in association with one or more confidential codes and, optionally, an identification of an initial referring party who first referred each member to the service provider. Then, the method comprises facilitating a search of the database by or on behalf of a searcher who is one of the members, to identify by confidential code at least one other member meeting criteria entered by the searcher. A meeting is ultimately arranged between the searcher and at least one other member identified in the search. Upon the searcher and the other member consummating a financial transaction, the service provider receives compensation from at least one of the searcher or the other member for facilitating the transaction. Optionally, the service provider shares with the initial referring party a portion of the compensation.

The invention also comprises a method for a supplier of capital to handle a rejection of a financial request by a first demander. The method comprises being a first supplier to refer the first demander to a service provider comprising an entity who collects data from the first demander and enters it into a database and makes that data available to one or more other suppliers in a pool, and then receiving compensation from the service provider if the first demander enters into a financial transaction with one of the other suppliers in the pool who accepts the first demander's financial request.

The invention further comprises a computer program product usable by a service provider and comprising at least one program storage device readable by a machine, tangibly embodying a program of instructions executable by the machine to perform a set of method steps for facilitating one or more financial transactions between one or more suppliers of capital, each supplier having a set of supply criteria (criteria used for lending, investment, charitable contribution, etc.), one or more demanders of capital, each demander having a request for financing, or at least two suppliers or at least two demanders. The method steps comprise recording data from a plurality of members comprising at least two suppliers, at least two demanders, or a combination thereof in a database in association with one or more confidential codes. The steps further include searching the database to identify by confidential code one or more members meeting criteria entered by a searcher. The steps next include providing an output of search results of at least a first level of information including the confidential code and general background information for the one or more other members. The program may optionally provide, in response to a follow-up selection of at least one of the other members identified in the search results, a second level of information comprising more information than the general background information, and still further optionally may receive and record an identification of at least one of the other members to meet with the searcher. The computerized steps ultimately include recording in the database any financial transaction between or among at least two members.

The invention further comprises a method for facilitating a financial transaction between a capital supplier and a capital demander. The method comprises establishing a capital supplier database containing at least one capital supplier identified by a first code and a plurality of standardized business information for each supplier, including supply criteria required by the capital supplier for supplying capital. The method also comprises establishing a capital demander database containing at least one capital demander identified by a second code and a plurality of standardized business information for each demander, including demand parameters related to the intended use of the capital. The capital supplier and capital demander databases are cross-referenced to identify at least one capital supplier and one capital demander wherein the one capital supplier's supply criteria substantially matches the one capital demander's demand parameters. The method further comprises initiating a controlled discourse between at least the one capital supplier and the one capital demander for the purpose of reaching agreement for the capital supplier to supply capital to the capital demander.

### BRIEF DESCRIPTION OF DRAWINGS

FIG. 1 is a flowchart detailing the steps of an exemplary supplier-driven method of this invention for matching suppliers with demanders.

FIG. 2 is a flowchart detailing the steps of an exemplary method of this invention for matching suppliers with other suppliers.

FIG. 3 is a flowchart detailing the steps of an exemplary demander-driven method of this invention for matching demanders with suppliers.

FIG. 4 is a flowchart detailing the steps of an exemplary method of this invention for matching demanders with other demanders.

### DETAILED DESCRIPTION OF INVENTION

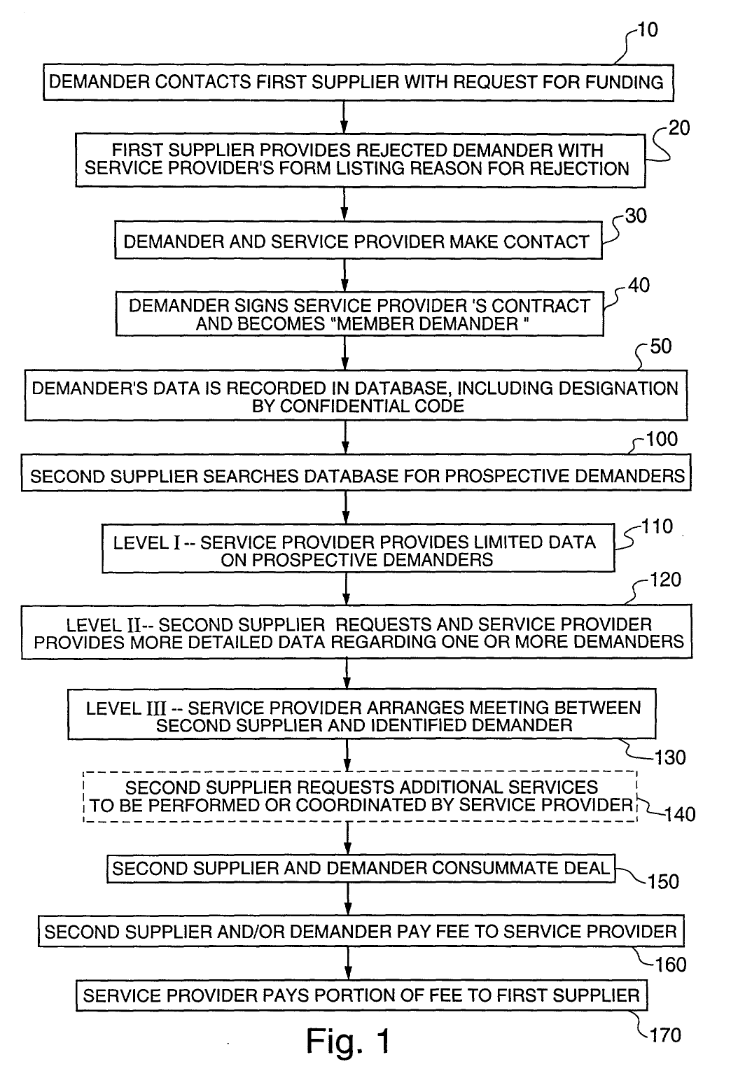

The invention will next be illustrated with reference to the figures. The figures are intended to be illustrative rather than limiting and are included herewith to facilitate the explanation of the method of this invention. Referring now to FIG. 1, there is shown a flowchart depicting an exemplary method of this invention. For ease of discussion, the term “demander” is used herein to designate the entity searching for funding and the term “supplier” is used to designate the entity desiring to supply funds. It should be understood, however, that the funds may be provided in any form that financing may take, including debt or equity financing.

In particular, the present method is applicable to any type of financing and any type of supplier offering such financing, including but not limited to venture capital; investment or merchant banking; consumer and commercial bank loans for real estate, equipment, mergers and acquisitions, credit cards, and the like; small business loans and investments (such as through the Small Business Investment Companies (SBIC) program); government and government agency loans and investments; charitable donations or grants; private equity placements; and funds such as mutual funds, leveraged buyout (LBO) funds, and hedge funds. The entities requesting funds may be any type of entity, including but not limited to individuals and sole proprietorships, corporations, partnerships, governments (federal, state, county, or local), government agencies, charities, institutions or endowments, unions, associations, or funds such as mutual funds, leveraged buyout (LBO) funds, and hedge funds.

Initially, a supplier may sign up for the services of the service provider by providing data about itself and the types of deals sought. The service provider assigns the supplier a confidential supplier code and records the supplier's data in a database that can be searched by demanders and other suppliers. “Confidential codes” as discussed herein may be any type of code, preferably an alphanumeric code that does not reveal or suggest the identity of the supplier or demander. The supplier then receives application forms, such as or including Standard Business Financing Forms (SBFF), as described herein later, to be distributed to future rejected demanders. Such a supplier who supplies information to the service provider and agrees to refer future rejected demanders to the service provider is referred to herein as a “member supplier.”

Referring now to FIG. 1, in step 10, a demander then contacts the member supplier with a request for funding. If the member supplier rejects the demander, he provides the demander with an SBFF, as indicated in step 20, noting on the form the reason for rejection of the demander. The member supplier may also send the service provider a periodic list of rejected demanders. Thus, the service provider may either (i) be contacted by the demander via the demander filling out the form and sending it in, or (ii) may initiate contact with the rejected demander using the list of rejected demanders provided by the supplier. The demander may also contact the service provider directly without initial supplier contact, such as by calling and requesting a form. Regardless of how the contact is initiated, the demander and the service provider ultimately make contact, as indicated in step 30, and the demander contracts with the service provider to provide services, thereby becoming a “member demander,” as indicated in step 40.

The demander may become a member demander by signing a contract sent by the service provider to the demander, and may need to provide supporting information and a fee. The contract may be part of the initial form, such as the SBFF, or may be a separate form provided to the demander after submitting the initial form. The supporting information may include, for example, a business plan, such as a standardized business plan as described herein, and an executive summary. Business plans and executive summaries, generally, are known in the art. Because a single demander may apply to more than one supplier prior to coming in contact with the service provider, the service provider may need to determine which supplier is the first to refer a specific demander to the service. The service provider may have a standard set of rules used in making this determination, such as choosing the supplier who refers the demander to the service earlier.

The service provider then records the demander's data in a limited-access database, as indicated in step 50, typically after checking the demander's application for completeness and accuracy. The demander's information may be listed by demander name or other information, or may be listed using a confidential code to protect the identity of the demander and to assure that the service provider can control the deal flow. The data record corresponding to each demander may further comprise a list of suppliers who have previously rejected that demander, and their reasons for doing so. The supplier information may also be designated using a confidential code.

The method of the present invention may then operate in a number of ways, some examples of which are detailed below. Searches of the member demander and supplier database may be initiated by suppliers, demanders, or both suppliers and demanders. The members may have direct access to the database, such as through a computer network, or may request the service provider to perform the search. Searches may also be initiated by the service provider, such as by the service provider periodically generating a list of suppliers that match selected member demanders' request profiles to be sent to the selected member demanders, and lists of demanders that match selected member suppliers' requirements to be sent to the selected member suppliers. Members receiving such periodic lists may pay a subscription fee.

Preferably the process operates with searches initiated by suppliers and demanders, but primarily by suppliers. The services described herein may be provided through any medium or combination or media, such as but not limited to computers, computer networks such as the Internet or a dedicated dial-up service, telephone, facsimile, and standard mail. Preferably, the invention is practiced using computer hardware and software to facilitate database creation and administration, searching, record-keeping, and list generation.

### SUPPLIER INITIATED PROCESS

Continuing to refer to the flowchart of FIG. 1, a second supplier next searches the database looking for potential demanders that satisfy his basic criteria, as indicated in step 100. The actual search may be performed by the second supplier through remote computer access, such as through a global information network such as the world wide web, or may be performed by the service provider at the request of the second supplier by telephone, fax, e-mail, paper mail, and the like. Then, in step 110 the service provider provides the supplier with general background data on the member demanders that meet the suppliers criteria, and may charge a fee for this service. This level of response is referred to herein as “Level I.” The general background data preferably identifies each demander only by the confidential code, and may also include data such as geographical data, amount of funds requested, business/financing stage (seed, start-up, mezzanine, growth, buyout, etc.), and industry/product/service data. The general background data may also include the confidential codes of other suppliers who have rejected the demander, along with reasons for and dates of the rejections. The service provider keeps track of the member demanders for whom the general background data was provided to each supplier. The data may be provided in the form of a computerized listing, or for example, a printed report sent by mail of facsimile.

Next in step 120, the supplier may then identify one or more of the demanders from the Level I list for which more information is desired. The service provider may then provide more detailed information, such as the business plan, any executive summaries, and a cleansed copy of the demander's application form, as indicated in step 120. This level of response may be referred to as a “Level II” response and may incur additional access/usage fee charged by the service provider. The information provided at this stage is preferably cleansed of any information from which the supplier could determine the identity of the demander, so that the supplier cannot circumvent the service provider by arranging a meeting and dealing directly with the demander. From this Level II information, the supplier may then identify at least one demander with whom the supplier would like to meet. The service provider then arranges for the supplier and identified demander to meet, as shown in step 130. This level of response is referred to herein as “Level III.”

Although described herein with a preferred 3-level response system, the information provided by the service provider to the suppliers (or demanders in methods described herein later) may be controlled such that there are fewer or more discrete levels of information provided. Also, although exemplary types of information or activities provided are identified above with respect to each level, the actual information or activity provided for each level of response may be any type of information that the service provider and/or searcher designates.

The supplier may optionally request additional services to be performed or coordinated by the service provider to further evaluate the demander, as indicated in step 140. For example, the supplier may have an accountant or consultant provided or referred by the service provider conduct an audit or background check of the demander, or the supplier may request that a search, such as a prior art search, or other analysis, such as a patentability or infringement opinion, be conducted to determine the validity of the demander's intellectual property and it's potential value. For example, an intellectual property audit may be performed, such as by the method described in U.S. Provisional Application Serial No. 60/240,135 and incorporated herein by reference. The service provider may charge a fee to the supplier or demander for the provision or coordination of such additional services, and/or may receive a portion of the amount billed by any third party who actually performs these additional services as coordinated by the service provider.

Once the supplier and demander consummate a deal, in step 150, one or both of the supplier and demander may be obligated to pay a brokerage or finder fee to the service provider at settlement, as indicated in step 160. The fee is preferably based on the value of the total deal between the supplier and demander. The demander may additionally provide compensation to the service provider in the form of warrants or other rights. The initial supplier who first rejected the demander and provided the name to the service provider is then paid a portion of this fee by the service provider, as indicated in step 170. Information about the completed transaction may then be entered into the database.

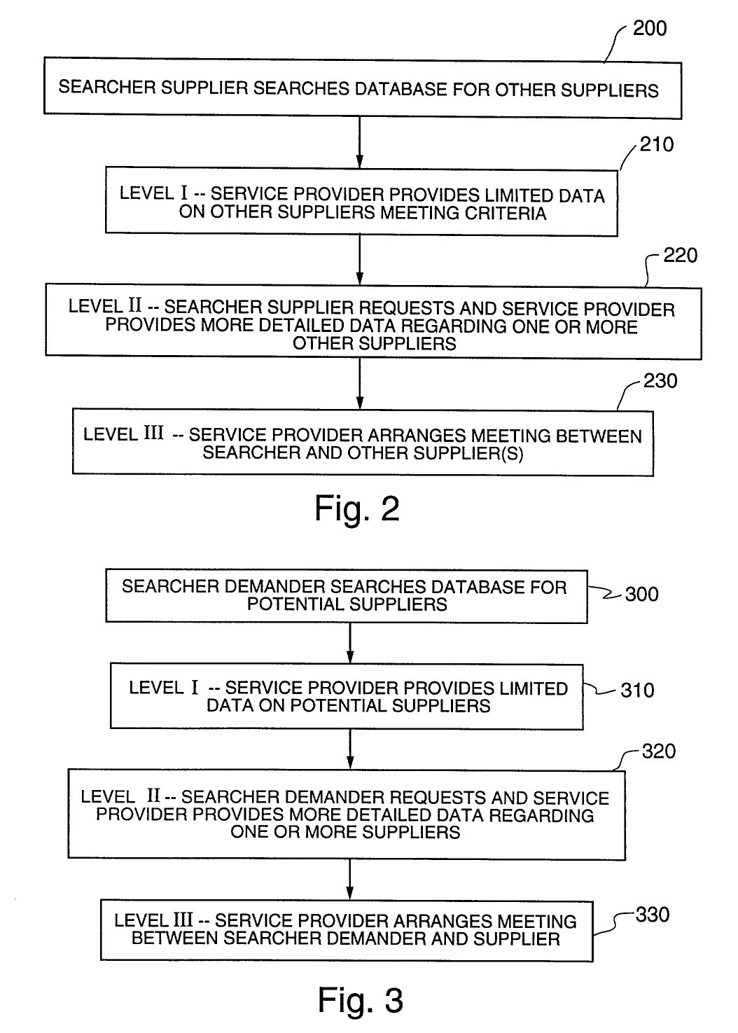

In another supplier initiated process depicted in FIG. 2, a searcher supplier may search the database for other suppliers, such as to find funds for existing deals in that supplier's portfolio or to find funds for new deals that either originate within or outside the process outlined above. In such a process, the searcher supplier searches the database as indicated in step 200 to find other suppliers that meet predetermined criteria. The service provider may then provide a Level I list of such suppliers, preferably listed only by confidential code and accompanied only by general data, typically in return for an access/usage fee, as indicated in step 210. The searcher supplier may then in step 220 identify certain suppliers from the Level I list for which more detailed information is desired, and may receive more detailed Level II information for such suppliers, again typically in return for an additional fee. Finally, the searcher supplier may indicate to the service provider at least one other supplier that it wishes to meet, and the service provider arranges a meeting as a Level III response, as shown in Step 230.

Similar to step 140 shown in FIG. 1, the service provider may further coordinate the provision of additional information or services to the searcher and/or other supplier, typically in return for a fee. Similar to steps 150 and 160 shown in FIG. 1, if the searcher and other supplier consummate a deal, one or both, typically the searcher supplier, pay a brokerage fee to the service provider, preferably based upon the total value of the additional funding provided by the other supplier. The service provider may then record data relating to the completed transaction in the database. Optionally, the party who referred one or both of the suppliers to the service provider may receive a portion of the compensation provided to the service provider.

### DEMANDER INITIATED PROCESS

Referring now to the flowchart of FIG. 3, an exemplary demander-initiated process will now be described. First, the demander contacts the service provider regarding the type of financing it is seeking. The demander, or the service provider on the demander's behalf, then searches the database for potential suppliers that may satisfy the demander's needs, as indicated in step 300. Then the service provider identifies one or more potential suppliers, preferably only by confidential code and other Level I information, as shown in step 310. From the Level I information, the demander may then request, and the service provider may provide, additional (Level II) information regarding one or more suppliers, as indicated in step 320. The demander typically is charged an access/usage fee for receiving each of the Level I and Level II information. Then, as indicated in step 330, the demander then identifies one or more suppliers with whom to meet and the service provider arranges a meeting (a Level III response). The process continues as described above with respect to steps 140-160 of FIG. 1, with optional additional services being provided or arranged by the service provider and one or both of the supplier or demander paying a broker's fee to the service provider upon consummation of a deal, from which the service provider pays a portion of the fee to the entity who initially rejected and referred the demander.

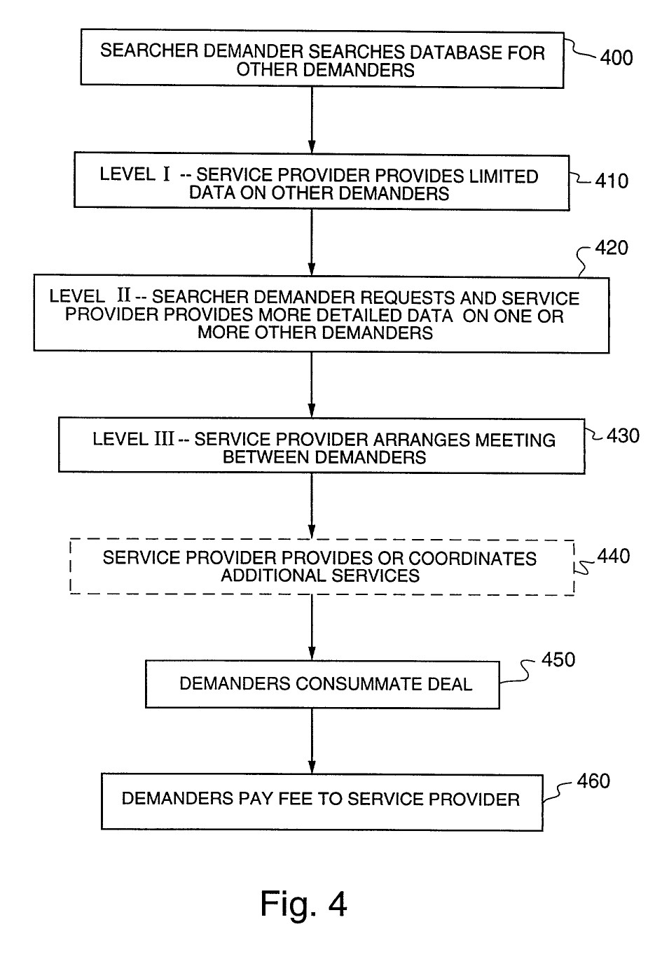

As shown in FIG. 4, a searcher demander may also wish to use the service to identify other demanders, such as to create a partnership, or to avoid overlapping business plans. In such a method, the searcher demander may first search the database for other demanders that meet predetermined criteria, as indicated in step 400. Then, the service provider may initially provide general (Level I) data for such demanders, preferably identified only by confidential code, as indicated in step 410, typically in return for an access/usage fee,. The searcher demander then identifies demanders from that list for which it is desired to receive additional information, and the service provider may then provide more detailed information, such as business plan and executive summary information (Level II), as indicated in step 420, typically in return for an additional fee. The searcher demander may then identify at least one other demander with whom to meet, as indicated in step 430, and the service provider arranges the meeting.

As shown in step 440, the service provider may provide or coordinate additional optional services, as described above. If the demanders consummate a deal in step 450, such as by which they partner with one another, the demanders may then pay a fee to the service provider in step 460. The fee may preferably be based upon the total value of the new financing obtained. For example, if each demander was already obligated to pay a first brokerage fee equaling a first percentage of the total value of a consummated deal with a supplier, the fee may be raised to a second percentage larger than the first percentage to reflect the added attractiveness of the deal presented by the two demanders together. In other situations, the supplier may be the only entity normally obligated to pay the brokerage fee, so that the partnering of demanders may obligate the demanders to pay a brokerage fee not otherwise owed. In still other situations, the brokerage fee for arranging a deal with another demander may be a flat fee that not contingent upon consummating a deal with a supplier. The increased fee may be shared with the party who referred the demander, or may be kept entirely by the service provider. In any of the methods described above, the service provider typically enters information into the database relating to any completed transaction between any members.

The system can work on multiple levels with multiple uses. Thus, for example, although venture capitalists are usually suppliers, the venture capitalists may also use the system as demanders with respect to government, institutional, company, and other sources of funds who are suppliers of funds that the venture capitalists draw upon to make their investments. Such sources of funds may, in turn, use the system as suppliers.

### DATABASE INFORMATION

As discussed above, to initiate the agreement between the service provider and the demander, the service provider gathers or is provided data from the demander. This data then becomes part of the data record for each demander that is searchable by member suppliers. The request for information may be contained in a standard form, which may be a paper form, an electronic form, or may be entered into the database by an operative of the service provider in conjunction with a question and answer session with the demander. The data collected by the service provider to create a financial profile of the demander falls within essentially three general areas: general information, the type of financing sought, and the names of suppliers to which the demander previously applied. The service provider may also provide the demander with a statement of the terms of the agreement between the demander and the service provider as part of the form, such as wherein submitting the form creates a contract between the demander and service provider.

Among the general information compiled by the service provider on the demander, include the demander's name and contact information, such as a designated contact person, the address, telephone number, fax number, e-mail address, and the like. A unique confidential code, such as an alphanumeric customer number, is then assigned to the demander to be used in the database.

Information collected about the type of financing sought may include a categorization of the industry/product/service or general field for which the financing is sought; the amount of financing and terms desired; a description of the financial need, preferably including an executive summary of the financing request and a business plan; and financial records, such as an income statement, a balance sheet, pro forma statements, and one or more tax returns.

For each supplier to which the demander has previously supplied, the demander may be asked to provide the name of the supplier; contact information, such as the address, telephone and fax numbers, and the names of specific contacts with whom the demander dealt with; the date of original application; the date of rejection; and the reason given for the rejection.

The information provided by the service provider to the demander includes advising the demander of its duty to provide accurate information to the service provider, its duty to inform the service provider if there is a subsequent transaction with a supplier whose name was supplied by the service provider, and its duty to pay certain fees under certain conditions. The fees may include any or all of a subscription fee for signing up for the service, an access fee for accessing the database of supplier names, a referral fee for each name provided, and brokerage fee upon settlement with a supplier found through the service.

The information may preferably be provided by way of a Standard Business Financing Form (SBFF), as described in U.S. Patent Application Serial No. 09/669,286, filed Sep. 26, 2000 (which claims priority of Provisional Application Serial No. 60/157,119), both of which are incorporated herein by reference. Such a form may include, but is not limited to, the following basic elements:

| | |
|---|---|
| 1. Name | 5. Fax number |
| 2. Type of Business | 6. Computer address |
| 3. Address - Street, mailing | 7. Years in Business |
| 4. Telephone number | 8. Credit Rating |

### STANDARDIZED BUSINESS PLAN

Because the method of this invention brings together a number of demands for funding in one place, it may be highly beneficial for suppliers to be able to adequately compare one request for funds with another. Thus, a beneficial feature of this invention is the use of a standard business plan that simplifies the analysis of a potential transaction, by organizing the data into a comprehensive and concise format. A preferred format may include the following information:

Business Market Description—an identification of the market(s) in which the demander's business serves or plans to serve

Business Goals—a listing of the demander's goals within the identified market.

Business Strategy—an explanation of how the demander plans to achieve its business goals.

Business Model—a description of the structure of the demander's business organization.

Business Pro Forma—projected revenues and expenses over a predetermined period of time, such as over the next 3-5 years.

Business Culture—an identification of the key operatives of the business who will execute the plan.

The “executive summary,” as referred to herein, typically comprises a digest or summary of the business plan, preferably comprising all of the same categories above.

### BENEFITS AND ADVANTAGES

The method of this invention standardizes and simplifies the proposal process as well as solves several problems for demanders. It provides broad exposure to suppliers beyond the initial contact and identifies such suppliers to the demander and helps the demander locate and contact such suppliers. In addition to creating a pool of suppliers that can be searched, the method also creates a pool of other demanders who can be searched. The method saves the demander time, energy and money otherwise spent searching for interested suppliers, by identifying and targeting only those suppliers with matching criteria and screening out those suppliers who have already rejected the demander's request. As an additional benefit, the method enables the identity of the demander to be kept confidential, except from interested suppliers. The method also standardizes the business plan format to make it more comprehensible and easier to analyze for suppliers and other demanders. Although ideally suited for helping demanders who have been initially rejected, the method of this invention and the database used in conjunction therewith can serve as a clearinghouse for demanders to use before even making a first request for funds from a supplier.

The invention reduces burden on and expense to suppliers by reducing the amount of time, energy and money spent servicing rejected demanders, while also helping the supplier provide better service to the rejected demanders. Initially, the service provides the supplier with someone to which to refer the demander, rather than leaving the demander with no place to go. The invention also creates a database of potential demanders from those rejected by other suppliers, providing a source where suppliers can access and search new prospects. In particular, the database may be mined to target demanders and their requests by various characteristics, such as the type or amount of financing sought, the names of suppliers already contacted, the financial terms sought (rate, downpayment, time, equity participation, collateral, etc.), and the like. This invention uniquely creates a revenue stream from rejected demanders by providing a referral fee to the supplier, either at the time of the initial referral, or when the rejected demander finally completes a transaction with another supplier. The confidentiality feature of using a confidential code to refer to each supplier, protects the supplier's identity with respect to which financing requests or demanders it has already rejected and with respect to what types of financial requests it is seeking.

The invention essentially creates a clearinghouse where a supplier can pick only the types of candidates it is seeking, thus screening out demanders and requests that do not satisfy its criteria, including screening out prospective demanders that have already been rejected by a particular financial firms. Additionally, the invention also creates a pool of other suppliers that the supplier can search for potential partners. The method also creates a standard business plan format that makes it easier for suppliers to search, analyze, and compare various requests for funds.

Compensation to the service provider may be generated by any or all of a number of fees, such as but not limited to a listing fee paid by each demander and/or supplier for the service of being listed by the service provider, an access fee paid by demanders and/or suppliers for being able to search the database, a periodic service fee for retaining a listing and/or access privileges, a referral fee paid per lead (per demander name supplied to a supplier, or per supplier name supplied to a demander), a subscription service fee (for a supplier or demander who has, for example, a standing order for lists to be automatically generated on a periodic basis listing entities that meet its criteria), consulting fees for analytical services (such as background reviews and prior art searches of potential partners or investment/loan candidates), and a brokerage fee for each completed transaction. Other types of fees may also be assessed, such as an equity interest, for example warrants on securities. An additional revenue source for the service provider may be through participation in deals as a source of capital.

The invention may be advantageously practiced through the use of computer software and hardware, and in particular, may be practiced via a global computer network such as the Internet, using known security measures to keep the information in the database securely accessible. Thus, the invention also comprises a computer program product comprising at least one program storage device readable by a machine, tangibly embodying a program of instructions executable by the machine to perform the method steps for facilitating one or more financial transactions between one or more suppliers and one or more demanders, or at least two demanders or at least two suppliers.

In particular, the method steps comprise recording data from a plurality of members comprising at least two suppliers, at least two demanders, or a combination thereof in a database in association with one or more confidential codes and, optionally, an identification of an initial referring party who first referred each to the service provider. The identification of the initial referring party may also be by a confidential code. The computer program may be adapted to deal with suppliers only, demanders only, or a combination of suppliers and demanders.

The program is adapted to search the database to identify by confidential code one or more members meeting criteria entered by a searcher. The searcher may be a supplier searching for a demander or other supplier, or a demander searching for a supplier or other demander. The program then provides an output of search results of at least a first level of information including the confidential code and general background information for the one or more other members. The program may optionally provide in response to a follow-up selection of at least one of the other members identified in the search results, a second level of information comprising more information than the general background information. Still further optionally, the program may receive and record an indication of at least one member to meet with the searcher. The program may be able, for example, to directly receive a selection from the searcher indicating which of the members identified in the Level I or II search, the searcher wishes to meet. The program may then notify the service provider to set up a meeting.

The computer program may operate actively or passively. Passive operation is defined as requiring user input to initiate the search and provide output. Active operation is defined as automatically initiating a search and providing at least the first level of output in response to a set of standing instructions. For example, a member may have a set of standing instructions to periodically receive a list of other members that may meet its criteria. The program may automatically provide this periodic list, including even sending the list automatically by e-mail or fax, or automatically printing it to be sent by other means. Thus, if a supplier wants to receive a list of all new demanders entered into the system each week seeking deals in the $1-2 million range, the computer program may automatically send him an e-mail every week with this information.

The program also records in the database any financial transaction between or among at least two members, including, optionally, the amount of compensation received for services rendered in conjunction with each financial transaction, and may further provide an output identifying a portion of the amount of compensation to be sent to at least one initial referring party. The term “output” as described herein may be in any form of computer output known in the art, such as a printed output, an output saved to a file, and preferably may also be displayed on the screen of the searcher.

The program of instructions may further comprise recording screening data for each demander identifying each supplier who has previously rejected that demander, such that when the searcher is a supplier, the program omits from the search results information corresponding to demanders previously rejected by the searcher. Similarly, the program may comprise recording screening data for each supplier identifying each demander previously rejected by that supplier, so that when the searcher is a demander, the output omits from the search results information corresponding to suppliers who have previously rejected the searcher. Similar screening information may be entered showing suppliers rejected by other suppliers and demanders rejected by other demanders, so that no searching party pays for output information regarding deals for which it already declined interest.

The information used to carry out the methods of this invention may be contained in single or multiple databases. For example, a capital supplier database may be established containing at least one capital supplier identified by a first code and a plurality of standardized business information for each supplier, including supply criteria required by the capital supplier for supplying capital. A capital demander database may be established containing at least one capital demander identified by a second code and a plurality of standardized business information for each demander, including demand parameters related to the intended use of the capital. The capital supplier and capital demander databases may then be cross-referenced to identify at least one capital supplier and one capital demander wherein the one capital supplier's supply criteria substantially matches the one capital demander's demand parameters. Then, the method may further comprise any means of initiating a controlled discourse between at least the one capital supplier and the one capital demander for the purpose of reaching agreement for the capital supplier to supply capital to the capital demander. The means for initiating the controlled discourses may be through the multi-level information flow process as described herein, or by any other means known in the art. The capital supplier and capital demander databases may be portions of a single database, where each data record identifies whether the record relates to a supplier or a demander, or may be two distinct and separate database files.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A method for a service provider to facilitate one or more financial transactions between one or more suppliers of capital, each supplier having a set of supply criteria, and one or more demanders of capital, each demander having a request for financing, the method comprising the steps of:
(a) receiving from a first supplier a referral regarding a first demander rejected by the first supplier;
(b) entering data about the first demander into a database in association with a confidential demander code, the data comprising general and financial information about the first demander and the first demander's request for financing;
(c) facilitating a search of the database by or on behalf of a second supplier to identify one or more prospective demanders that satisfies the second supplier's set of supply criteria;
(d) arranging a meeting between the second supplier and the first demander;
(e) upon the first demander and the second supplier consummating a financial transaction, receiving compensation from the first demander, the second supplier, or both, for facilitating the transaction between the first demander and the second supplier; and
(f) sharing with the first supplier a portion of the compensation.

2. The method of claim 1 wherein step (c) comprises (i) initially identifying the one or more prospective demanders only by the confidential demander code and general background information, then (ii) receiving a request from the supplier for additional information on selected prospective demanders, and (iii) providing such additional information on the demanders identified in step (c)(ii).

3. The method of claim 2 wherein the general background information comprises information regarding the geographical region, amount of funds requested, business/financing stage, and industry/product/service type of the demander and the additional information comprises business plan information, executive summary information, or both, wherein the additional information is cleansed of data from which the demander's identity can be determined.

4. The method of claim 1 further comprising:
(g) collecting data from a third supplier and entering that data into a database in association with a confidential supplier code, the data comprising information about the third supplier, the third supplier's set of supply criteria, and optionally, an identification of an initial referring party who first referred the third supplier to the service provider;
(h) facilitating a search of the database by or on behalf of a second demander to identify by confidential supplier code one or more prospective suppliers qualified to satisfy the second demander's request for financing and for whom the second demander satisfies the supplier's set of supply criteria;
(i) upon the second demander and the third supplier consummating a financial transaction, receiving compensation from the second demander, the third supplier, or both, for facilitating the transaction between the second demander and the third supplier; and
(j) optionally, sharing with the initial referring party a portion of the compensation for facilitating the transaction between the second demander and the third supplier.

5. The method of claim 1 further comprising collecting data from a third demander and entering that data into the database, the third demander comprising a demander not referred by a supplier.

6. The method of claim 1 wherein the financial transaction comprises a transaction selected from a group consisting of: venture capital funding; investment and merchant bank funding; consumer and commercial bank loans; small business loans and investments; government and government agency loans and investments; charitable donations and grants; private equity placements; and fund financing.

7. The method of claim 1 wherein the first demander comprises an entity selected from a group consisting of: individuals and sole proprietorships, corporations, partnerships, governments, government agencies, charities, institutions and endowments, unions, associations, and funds.

8. The method of claim 1 further comprising receiving a fee from the second supplier for performing step (c).

9. The method of claim 2 further comprising receiving a fee from the second supplier for performing step (c)(i) and an additional fee for performing step (c)(iii).

10. A method for a service provider to facilitate one or more financial transactions among one or more suppliers of capital, each supplier having a set of supply criteria, one or more demanders of capital, each demander having a request for financing, or a combination thereof, the method comprising the steps of:
(a) collecting data from a plurality of members comprising at least two suppliers, at least two demanders, or a combination thereof, and entering the data for each member into a database in association with one or more confidential codes and, optionally, an identification of an initial referring party who first referred each to the service provider;
(b) facilitating a search of the database by or on behalf of a searcher who is one of the members, to identify by confidential code at least one other member meeting criteria entered by the searcher;
(c) arranging a meeting between the searcher and at least one of the other members identified in step (b);
(d) upon the searcher and at least one other member consummating a financial transaction, receiving compensation from at least one of the searcher or the other member for facilitating the transaction; and
(e) optionally, sharing with the initial referring party a portion of the compensation.

11. The method of claim 10 wherein the searcher comprises a supplier and the other member comprises at least one demander.

12. The method of claim 10 wherein the searcher comprises a supplier and the other member comprises at least one supplier.

13. The method of claim 10 wherein the searcher comprises a demander and the other member comprises at least one supplier.

14. The method of claim 10 wherein the searcher comprises a demander and the other member comprises at least one demander.

15. The method of claim 10 wherein the method has more than one application in a capital supply process such that the searcher is a first supplier for one type of financial transaction and is a demander for another type of financial transaction that involves a second supplier.

16. The method of claim 10 wherein step (c) comprises (i) initially identifying the at least one other member only by the confidential code and general background information, then (ii) receiving a request from the searcher for additional information on at least one selected member, and (iii) providing such additional information on the selected member identified in step (c)(ii).

17. The method of claim 16 wherein the general background information comprises information regarding the geographical region, amount of funds requested, business/financing stage, and industry/product/service type of the other member.

18. The method of claim 16 wherein the additional information is cleansed of data from which the identity of the other member can be determined.

19. The method of claim 10 further comprising the service provider periodically providing to a first member a list of one or more other members, identified by confidential code, meeting criteria of interest to the first member.

20. A method for a supplier of capital to handle a rejection of a financial request by a first demander, the method comprising the steps of:
(a) being a first supplier to refer the first demander to a service provider comprising an entity who collects data from the first demander and enters it into a database and makes that data available to one or more other suppliers in a pool; and
(b) receiving compensation from the service provider if the first demander enters into a financial transaction with one of the other suppliers in the pool who accepts the first demander's financial request.

21. A computer program product usable by a service provider and comprising at least one program storage device readable by a machine, tangibly embodying a program of instructions executable by the machine to perform a set of method steps for facilitating one or more financial transactions between one or more suppliers of capital, each supplier having a set of supply criteria, and one or more demanders of capital, each demander having a request for financing, or among at least two suppliers or at least two demanders, the method steps comprising:
(a) recording data from a plurality of members comprising at least two suppliers, at least two demanders, or a combination thereof, in a database in association with one or more confidential codes;
(b) conducting a search of the database to identify by confidential code one or more other members meeting criteria entered by a searcher;
(c) providing (i) an output of search results of at least a first level of information including the confidential code and general background information for the one or more other members, and optionally, (ii) in response to a follow-up selection of at least one of the other members identified in the search results, a second level of information comprising more information than the general background information; and further optionally, (iii) receiving and recording an identification of at least one of the other members to meet with the searcher;
(d) recording in the database each financial transaction between or among members.

22. The computer program product of claim 21 wherein step (a) comprises recording with respect to at least one member, an identification of an initial referring party who first referred each to the service provider and step (d) comprises recording an amount of compensation received for services rendered in conjunction with at least one financial transaction including the at least one member; and the method steps further comprise:
e) providing an output identifying a portion of the amount of compensation to be sent to the initial referring party.

23. The computer program product of claim 21 in which the program of instructions further comprises in step (a) recording screening data for each demander identifying each supplier who has previously rejected that demander; and in step (c), when the searcher is a supplier, omitting from the search results information corresponding to demanders previously rejected by the searcher.

24. The computer program product of claim 21 in which the program of instructions further comprises in step (a) recording screening data for each supplier identifying each demander previously rejected by that supplier; and in step (c), when the searcher is a demander, omitting from the search results information corresponding to suppliers who have previously rejected the searcher.

25. The computer program product of claim 21 in which the product operates passively, wherein steps (b) and (c) are initiated by a user input, and actively, wherein steps (b) and (c)(i) are initiated automatically in response to a set of standing instructions.

26. A method for facilitating a financial transaction between a capital supplier and a capital demander, the method comprising:
establishing a capital supplier database containing at least one capital supplier identified by a first code and a plurality of standardized business information for each supplier, including supply criteria required by the capital supplier for supplying capital;
establishing a capital demander database containing at least one capital demander identified by a second code and a plurality of standardized business information for each demander, including demand parameters related to the intended use of the capital;
cross-referencing the capital supplier and capital demander databases to identify at least one capital supplier and one capital demander wherein the one capital supplier's supply criteria substantially matches the one capital demander's demand parameters; and
initiating a controlled discourse between at least the one capital supplier and the one capital demander for the purpose of reaching agreement for the capital supplier to supply capital to the capital demander.
